(19) United States
(12) Patent Application Publication
(10) Pub. No.: US 2007/0080583 A1
(43) Pub. Date: Apr. 12, 2007

(54) Vehicle and control method for changing control mode of driving and braking force based on change rate of wheel vertical load

(75) Inventors: Shin Noumura, Susono-shi (JP); Ken Koibuchi, Hadano-shi (JP); Hisashi Kajita, Suntou-gun (JP); Yuichi Mizuta, Suntou-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/543,906

(22) Filed: Oct. 6, 2006

(30) Foreign Application Priority Data
Oct. 7, 2005 (JP) 2005-295092

(51) Int. Cl. B60T 8/68

(52) U.S. Cl. 303/175

(57) ABSTRACT

A vehicle is provided in which, when a slip between a wheel and a road surface is increased, a driving and braking control is performed to reduce the slip. A change rate in a wheel vertical load is determined. A mode of the driving and braking control is changed based on the determined change rate. The change of mode may be performed by changing at least one of the start of the driving and braking control, the reduction rate or the lower bound during the temporary reduction of the braking force or driving force, and the increasing rate during increasing the braking or driving force after the temporary reduction, or the like, according to the change rate in the wheel vertical load.

### INCORPORATION BY REFERENCE

The disclosure of Japanese Patent Application No. 2005-295092 filed on Oct. 7, 2005 including the specification, drawings and abstract is incorporated herein by reference in its entirety.

### BACKGROUND OF THE INVENTION

1. Field of the Invention

The present invention relates to a driving and braking force control, in particular, relates to an improved driving and braking force control in an anti-lock braking system (ABS) or a traction control system (TRC or TCS)

2. Description of the Related Art

When a wheel slips on the road surface and stops the rotation thereof while a braking force is applied to the wheel, the braking force does not work. On the other hand, when the wheel slips on the road surface and spins free while a driving force is applied to the wheel, the driving force does not work. The degree of traction (grip) or the degree of slip of a wheel on the road surface varies depending upon the product of the wheel vertical load and the friction coefficient between road surface and wheel. It is known that the increase of wheel vertical load is effective to suppress (minimize) the slip of wheel on the road surface. For example, in Japanese Patent Application Publication No. 10-203333 (JP-A-10-203333), a pattern of ABS control is changed in accordance with the wheel vertical load.

Because the traction (grip) or slip of wheel on the road surface varies depending upon the wheel vertical load, the amount of driving and braking force control (i.e., the level or degree how much the control is performed) may be changed based on the amount of wheel vertical load. However, the driving and braking force control, such as the ABS and TRC, that suppresses the slip is a relatively dynamic control, in which the force applied to the wheel along the road surface, such as a driving force and a braking force, is once reduced and then is gradually increased. Accordingly, the optimal (most appropriate) control mode may vary depending upon various factors as well as the amount of the wheel vertical load.

### SUMMARY OF THE INVENTION

The present invention provide a vehicle that performs the driving and braking force control more appropriately by improving the ABS control and the TRC control.

In one aspect of the present invention, a vehicle is provided, in which when a slip between a wheel and a road surface is increased, a driving and braking force control is performed to reduce the slip; a change rate in a wheel vertical load is determined; and a mode of the driving and braking force control is changed based on the determined change rate.

According to the aspect of the present invention, the change in the wheel vertical load is predicted, and the braking force and driving force of the wheel are dynamically changed. Thus, weakening of the braking and driving force of the wheel are minimized (suppressed), and the suppression of wheel slip is improved.

The driving and braking force control may be started when a slip rate between the wheel and the road surface exceeds a threshold value. The mode may be changed by setting the threshold value to greater when the wheel vertical load increases, as compared with when the wheel vertical load does not increase. Alternatively, the mode may be changed by setting the threshold value to smaller when the wheel vertical load decreases, as compared with when the wheel vertical load does not decrease.

Accordingly, the subsequent increase or decrease of the wheel vertical load can be predicted. Thus, the timing of starting the driving and braking force control can be more appropriately determined, in consideration of the difference in progression level of the slip, which is caused by the difference in the increasing and decreasing feature (tendency) of the wheel vertical load.

The driving and braking force control may reduce the force applied to the wheel along the road surface to a predetermined value and then gradually increase. The mode may be changed by setting the predetermined value to greater when the wheel vertical load increases, as compared with when the wheel vertical load does not increase. Alternatively, the mode may be changed by setting the predetermined value to smaller when the wheel vertical load decreases, as compared with when the wheel vertical load does not decrease.

Accordingly, the target value, to which the braking force or driving force applied to the wheel is initially reduced to eliminate the wheel slip, can be more appropriately determined by predicting the subsequent increase or decrease of the wheel vertical load.

The driving and braking force control may reduce the force applied to the wheel along the road surface to a predetermined value and then gradually increase. The mode may be determined by setting a higher increasing rate at which the force is increased, when the wheel vertical load increases, as compared with when the wheel vertical load does not increase. Alternatively, the mode may be determined by setting a lower increasing rate at which the force is increased, when the wheel vertical load decreases, as compared with when the wheel vertical load does not decrease.

Accordingly, the gradual increase of the once reduced braking or driving force of the wheel can be more appropriately determined by predicting the subsequent increase or decrease of the wheel vertical load.

The driving and braking force control may reduce the force applied to the wheel along the road surface to a predetermined value and then gradually increase. The mode may be changed by setting a lower reduction rate at which the force is reduced, when the wheel vertical load increases, as compared with when the wheel vertical load does not increase. Alternatively, the mode may be changed by setting a higher reduction rate, when the wheel vertical load decreases, as compared with when the wheel vertical load does not decrease.

Accordingly, the urgency of temporary reduction in the braking or driving force of the wheel can be more appropriately determined by predicting the subsequent increase or decrease of the wheel vertical load.

The mode may be changed so that the change rate of the wheel vertical load may be rated augmentatively, when the wheel wears at least one of a tire chain and a non-standard tire, such as a studless tire and other winter tire, as compared with when the wheel wears neither the tire chain nor the non-standard tire.

The controllability of the wheel is determined by the product of the wheel vertical load and the friction coefficient between the road surface and the wheel. When the wheel wears a tire chain or a studless tire, the friction coefficient between the road surface and the wheel increases. Thus, the wheel vertical load to obtain the same controllability can be smaller for the increased amount of the friction coefficient. Accordingly, when the wheel wears the tire chain or the studless tire, the weakening of the braking force or driving force of the wheel can be minimized and the driving and braking force control efficiency can be improved appropriately, in consideration of the increase of the friction coefficient between the road surface and the tire.

The mode may be changed so that the driving and braking force control ignores the temporary change in the wheel vertical load caused by an impulse-like protrusion or a bump on the road surface, or a jump.

Accordingly, the driving and braking force control may be prevented from being affected by an unpreferable external disturbance, caused by a simple and momentary decrease or increase generated by the impulse-like protrusion or the bump on the road surface, or the jump.

The driving and braking force control may be preformed in an ABS control or a TRC control.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a block diagram illustrating a main configuration of a vehicle performs a driving and braking force control, according to an embodiment of the present invention;

FIG. 2 is a block diagram illustrating functional units that perform the driving and braking force control, and signal transmission therebetween in the vehicle according to the embodiment of the present invention;

FIGS. 3A and 3B are flowcharts illustrating a driving and braking force control according to the embodiment of the present invention, when a braking control is performed;

FIG. 4 is a map (graph) illustrating a change in braking force applied to a wheel over time in the driving and braking force control according to the embodiment of the present invention;

FIG. 5 is a map (graph) that is similar to the map shown in FIG. 4, and in which the slip rate threshold value Swo(f) is set to constant regardless of the flag f;

FIG. 6 is a map (graph) that is similar to the map shown in FIG. 4 or FIG. 5, and in which Mapd1(t), Mapd2(t) and Mapd3(t) are identical;

FIGS. 7A and 7B are flowcharts illustrating a driving and braking force control according to another embodiment of the present invention, when a driving force control is performed;

FIG. 8 is a map (graph) illustrating a change in driving force applied to the wheel over time in a driving and braking force control according to the embodiment of the present invention,

FIG. 9 is a map (graph) that is similar to the map shown in FIG. 8, and in which the slip rate threshold value Swo(f) is set to constant regardless of the flag f;

FIG. 10 is a map (graph) that is similar to the map shown in FIG. 8 or FIG. 9, and in which Mapd1(t), Mapd2(t) and Mapd3(t) are identical;

### DETAILED DESCRIPTION OF THE PREFERRED EMBODIMENTS

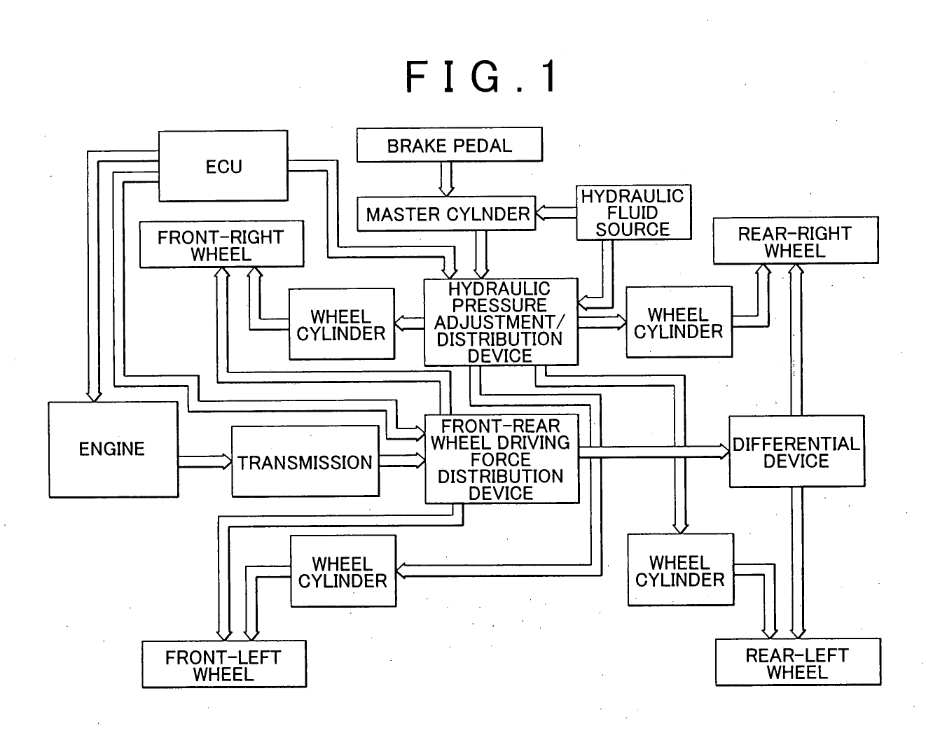

FIG. 1 is a block diagram illustrating a main configuration of a vehicle that performs a driving and braking force control for reducing a slip between a wheel and a road surface, when the slip is increased, according to an embodiment of the present invention.

As shown in FIG. 1, the vehicle is a four-wheeled vehicle having a front-left wheel, front-right wheel, rear-left wheel and rear-right wheel. Each of the front-left and front-right wheels is driven by an engine through a transmission and a front-rear wheel driving force distribution device (transfer case). The mutual rotation between the front-left and front-right wheels is adjusted differentially by a differential mechanism mounted in the front-rear wheel driving force distribution device. The rear-left and rear-right wheels are driven mutually differentially by the engine through the transmission, the front-rear wheel driving force distribution device and a differential device. The front-rear wheel driving force distribution device includes the differential mechanism, a clutch, a brake, or the like, and dynamically controls the distribution of driving forces between the front and rear wheels.

The front-left, front-right, rear-left and rear-right wheels are respectively provided with wheel cylinders that put a brake on the rotation of respective wheels by the supply of hydraulic pressures. Brake fluids are supplied to a hydraulic pressure adjustment/distribution device from a hydraulic fluid source directly or through a master cylinder, which is operated with a brake pedal. The brake fluids then supplied to the wheel cylinders under the hydraulic pressure adjustment/distribution control of the hydraulic pressure adjustment/distribution device.

An electric control unit (ECU) having a microcomputer controls the engine, front-rear driving force distribution device and the hydraulic pressure adjustment/distribution device. The driving and braking force control in the vehicle of the present invention is virtually (substantially) performed with the calculation by the microcomputer in the electric control unit. The schematic configuration of the vehicle as shown in FIG. 1 is known in the field of this art.

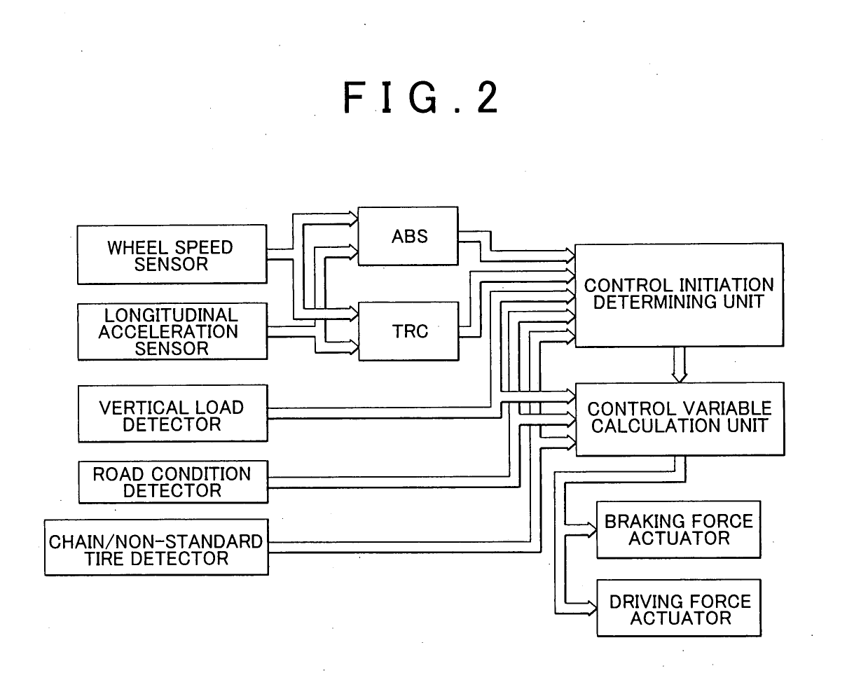

FIG. 2 is a block diagram illustrating functional units and signal transmission between the functional units to change the mode of driving and braking force control based on the change rate (rate of change) in wheel vertical load, in the vehicle according to the embodiment of the present invention. ABS and TRC respectively represent an anti-lock braking system and a traction control system. The core of the control of ABS and TRC is the ECU. A standard structure (configuration) of the ABS and TRC is known in the field of this art. A wheel speed sensor, which detects the wheel speed of each wheel, and a longitudinal acceleration sensor, which detects the longitudinal acceleration of the vehicle, respectively supply a signal indicating the wheel speed of each wheel and a signal indicating the longitudinal acceleration of the vehicle, to the ABS and TRC. Then, the ABS and TRC respectively perform control operations (calculations) of the ABS control and TRC control, and output the results of the calculations to a control initiation determining unit. The core of the control initiation determining unit is also the ECU. The control initiation determining unit outputs a control signal to a control variable calculation unit.

The control initiation determining unit receives a signal indicating a vertical load of each wheel from a vertical load detector, in addition to the control signals from the ABS and TRC. The vertical load detector, which detects a vertical load of a wheel, is also known in the field of this art. The signal indicating the vertical load of each wheel, detected by the vertical load detector is also supplied to the control variable calculation unit. The control initiation determining unit further receives a signal of road condition from a road condition detector. In this embodiment, the signal of road condition is a signal output when the wheel rolls over impulse-like protrusions or bumps on the road surface. The signal of road condition is also supplied to the control variable calculation unit. The control initiation determining unit also receives a signal from a chain/non-standard tire detector. The chain/non-standard tire detector outputs the signal when the wheel wears a tire chain or a non-standard tire, such as a studless tire or other winter tire. The chain/non-standard tire detector also supplies the signal regarding the tire chain or driving/braking force controllable tire, to the control variable calculation unit.

The core of the control variable calculation unit is the ECU. The control variable calculation unit calculates control variables regarding the driving and braking force control based on a control initiation command (control signal) by the control initiation determining unit and other signals supplied thereto as described above. Then, the control variable calculation unit actuates either a braking control actuator or a driving control actuator according to the calculated control variables.

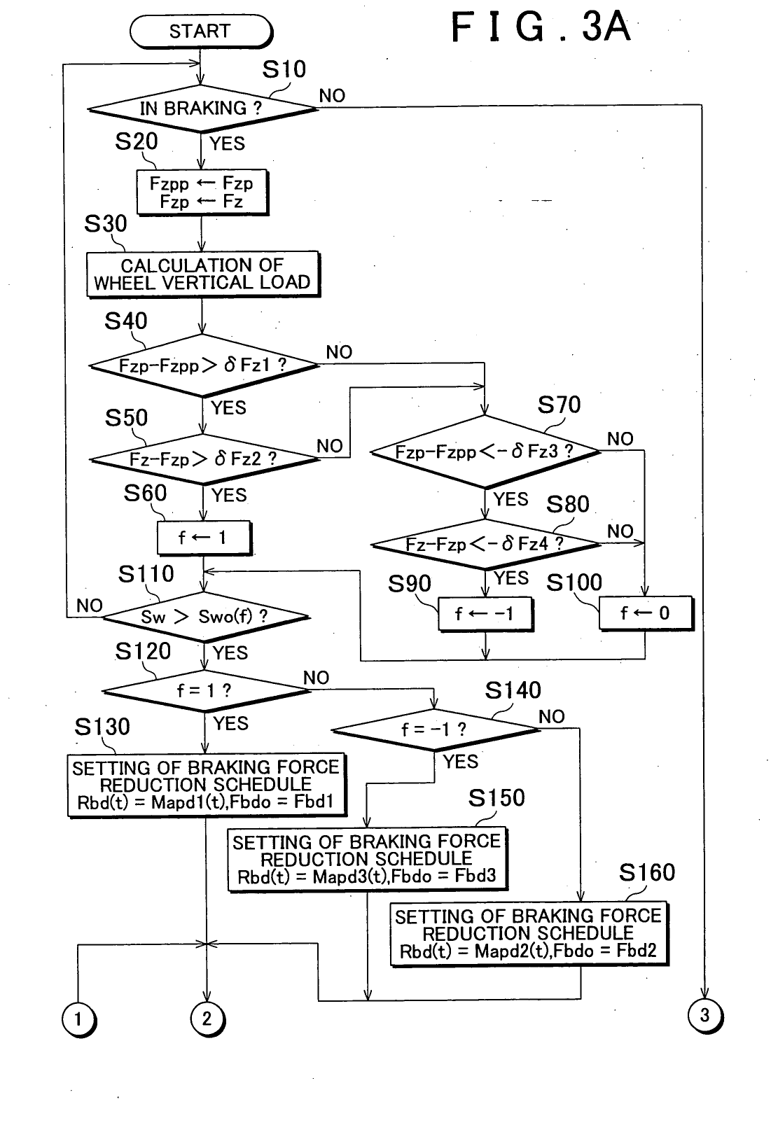

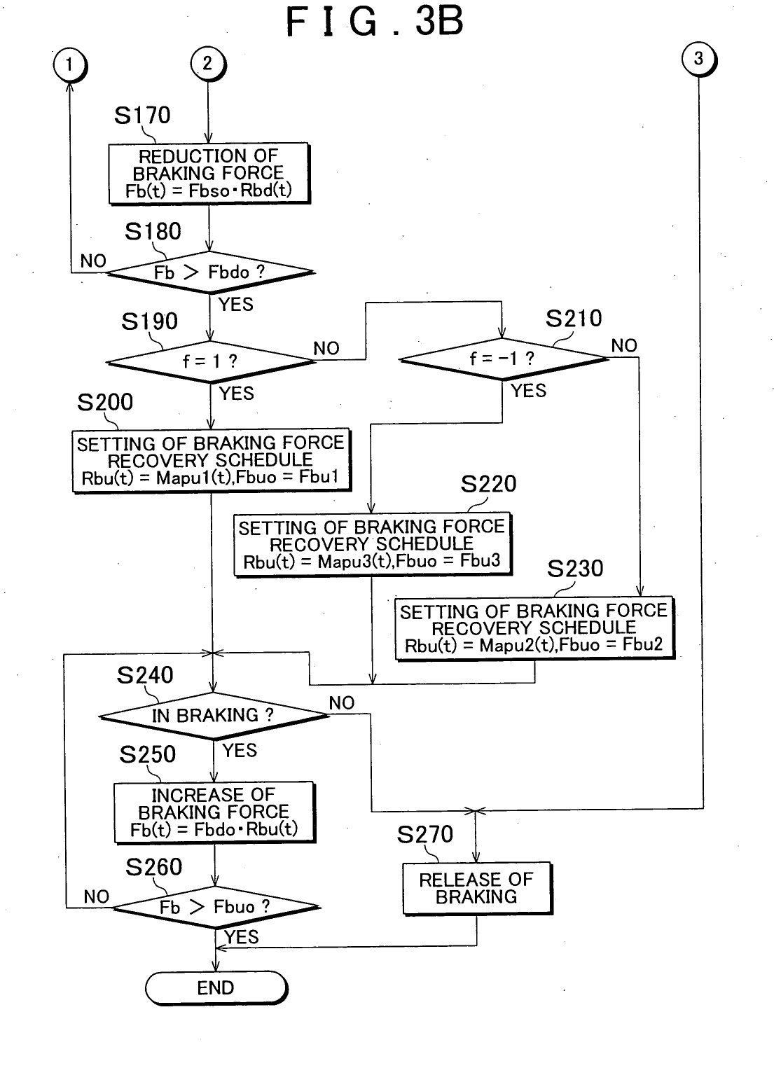

FIGS. 3A and 3B are flowcharts illustrating a driving and braking force control in a braking control (ABS control) performed using the functional configuration as shown in FIG. 2, on a vehicle having a structure as shown in FIG. 1, according to the embodiment of the present invention. The control shown in the flowchart may be performed individually for each of the front-left, front-right, rear-left and rear-right wheels. Alternatively, the wheels may be divided into front wheels and rear wheels, and the control may be performed separately on the pair of front wheels and the pair of rear wheels.

After the vehicle starts moving, in step 10, determination is made as to whether the vehicle is braking (or whether a specific wheel is braking). The braking may includes both a braking invoked when the driver depresses the brake pedal, and an automatic braking performed by the ABS in the ECU or a variety of known vehicle turning (steering) control devices. If the vehicle is braking, and thus affirmative determination is made in step 10, then, the control proceeds to step 20.

In step 20, the wheel vertical load that was calculated in step 30 of this flowchart in the two cycles before, and has been stored as Fzp, is set to Fzpp. Then, the wheel vertical load that was calculated in step 30 of this flowchart in the last cycle, and has been stored as Fz, is set to Fzp. The values of Fz and Fzp in the first and second cycles are zero, which are reset at the time of start-up.

In step 30, a current wheel vertical load Fz is calculated (determined).

In step 40, determination is made as to whether the difference obtained by subtracting Fzpp from Fzp is greater than a predetermined positive minute value δFz1 (i.e., Fzp−Fzpp>δFz1?). If affirmative, the control proceeds to step 50, in which determination is made as to whether the difference obtained by subtracting Fzp from Fz is greater than a predetermined positive minute value δFz2 (i.e., Fz−Fzp>δFz2?). If affirmative, the control proceeds to step 60, in which the flag f is set to one (1). If a negative determination is made in either step 40 or step 50, the control proceeds to step 70, in which determination is made as to whether the difference obtained by subtracting Fzpp from Fzp is smaller than a predetermined negative minute value −δFz3, or whether the absolute value of the difference is larger than δFz3 (i.e., Fzp−Fzpp<−δFz3?). If affirmative, the control proceeds to step 80, in which determination is made as to whether the difference obtained by subtracting Fzp from Fz is smaller than a predetermined negative minute value −δFz4 (i.e., Fz−Fzp<−δFz4?). Then, if affirmative, the control proceeds to step 90, in which the flag f is set to minus one (−1). If a negative determination is made in either step 70 or step 80, the control proceeds to step 100, in which the flag f is set to zero (0).

According to the above-described processing in steps 20 to 100, the flag f is set to one (1) when the wheel vertical load Fz increases at a change rate greater than a predetermined value defined by bFz1 and δFz2. The flag f is set to minus one (−1) when the wheel vertical load Fz decreases at a change rate greater than a predetermined value defined by −δFz3 and −δFz4. The flag f is set to zero (0) when the change rate (rate of change) in the wheel vertical load Fz is within a predetermined small range, which is close to zero (0). The processing in steps 20 to 100 may be an example that realizes a change rate calculator.

In step 110, determination is made as to whether the slip rate Sw of the wheel is greater than a predetermined threshold value Swo(f), which is determined based on the flag f. In this embodiment, Swo(1) is greater than Swo(0) and Swo(0) is greater than Swo(−1) (i.e., Swo(1)>Swo(0)>Swo(−1)). If negative in step 110, the control returns to before step 10, and the steps 10 to 110 are repeated. If the determination in step 10 is changed from affirmative to negative, in other words, if the driver releases the depression of the brake pedal or the braking operation based on the automatic control by the ECU ends during the above-described control processing, the control proceeds to step 270, in which the brakes are released and the control according to this flowchart ends.

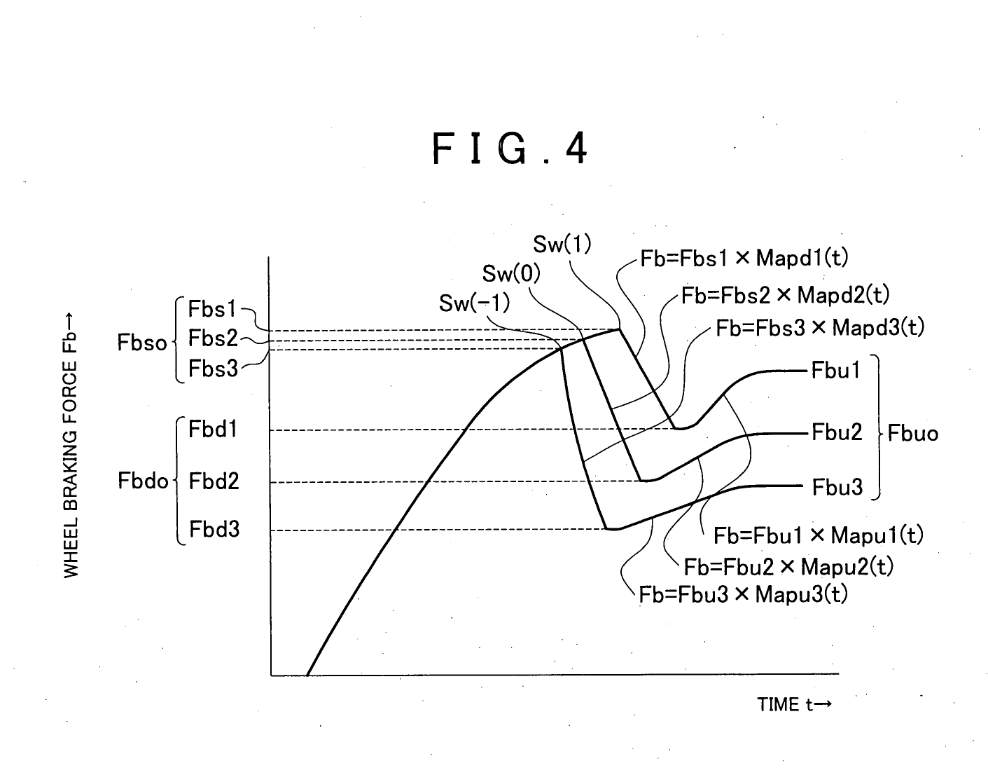

If affirmative determination is made in step 110 because the slip of the wheel is increased by braking, the control proceeds to step 120, in which determination is made as to whether the flag f is equal to one (1). If affirmative, the control proceeds to step 130, in which a braking force reduction schedule used when the wheel vertical load increases at a relatively large change rate, is set. In this reduction schedule, the braking force Fb is reduced in accordance with the curve of Mapd1(t) from Fbs1 to Fbd1, as shown in the map of FIG. 4. FIG. 4 illustrates the change in the wheel braking force Fb over time t in the driving and braking force control in braking according to the embodiment of the present invention. Fbs1 is the braking force when the slip rate is Swo(1). Thus, the braking force reduction rate Rbd(t) is set to Mapd1(t).

If negative determination is made in step 120, the control proceeds to step 140, in which determination is made as to whether the flag f is equal to minus one (−1). If affirmative, the control proceeds to step 150, in which the braking force reduction schedule used when the wheel vertical load decreases at a relatively large change rate, is set. In this reduction schedule, the control force Fb is reduced from Fbs3 to Fbd3 in accordance with the curve Mapd3(t) as shown in the map of FIG. 4. The Fbs3 is the braking force when the slip rate is Swo(−1). Thus, the braking force reduction rate Rbd(t) is set to Mapd3(t).

If negative determination is made in step 140, the control proceeds to step 160, in which the braking force reduction schedule used when the change rate of the wheel vertical load is within the relatively small range, which is close to zero (0), is set. In this reduction schedule, the control force Fb is reduced from Fbs2 to Fbd2 in accordance with the curve Mapd2(t) as shown in the map of FIG. 4. The Fbs2 is the braking force when the slip rate is Swo(0). Thus, the braking force reduction rate Rbd(t) is set to Mapd2(t). The steps 110 to 160 may be an example of implementation of a mode calculator.

Then, in step 170, the braking force is reduced according to the selected one of the above-described reduction schedules. In other words, the braking force is reduced over time at the braking force reduction rate Rbd(t) (one of Mapd1(t), Mapd2(t) and Mapd3(t)) from the initial braking force Fbso (one of Fbs1, Fbs2 and Fbs3), which is the braking force from which the reduction begins.

In step 180, determination is made as to whether the braking force Fb is reduced to the reduction lower bound Fbdo (one of Fbd1, Fbd2 and Fbd3, set as described above). If negative, the control returns to before step 170, and the control in step 170 is repeatedly performed. If the determination changes from negative to affirmative in step 180, then the control proceeds to step 190.

In step 190, determination is made as to whether the flag f is equal to one (1). If affirmative, the control proceeds to step 200, in which the braking force recovery schedule used when the wheel vertical load increases at a relatively large change rate, is set. In this recovery schedule, the braking force Fb is increased in accordance with the curve Mapu1(t) from the reduction lower bound Fbdo (=Fbd1) to Fbu1, as shown in the map of FIG. 4. Thus, the braking force recovery rate Rbu(t) is set to Mapu1(t).

If negative determination is made in step 190, the control proceeds to step 210, in which determination is made as to whether the flag f is equal to minus one (−1). If affirmative, the control proceeds to step 220, in which the braking force recovery schedule used when the wheel vertical load decreases at a relatively large change rate, is set. In this recovery schedule, the braking force Fb is increased in accordance with the curve Mapu3(t) from the reduction lower bound Fbdo (=Fbd3) to Fbu3, as shown in the map of FIG. 4. Thus, the braking force recovery rate Rbu(t) is set to Mapu3(t).

If negative determination is made in step 210, the control proceeds to step 230, in which the braking force recovery schedule used when the change rate of the wheel vertical load is within the relatively small range, which is close to zero (0), is set. In this recovery schedule, the braking force Fb is increased in accordance with the curve Mapu2(t) from the reduction lower bound Fbdo (=Fbd2) to Fbu2, as shown in the map of FIG. 4. Thus, the braking force recovery rate Rbu(t) is set to Mapu2(t). The steps 190 to 230 may also be an example of implementation of a mode calculator.

In step 240, confirmatory determination is made once again as to whether braking is still being applied. If affirmative, the control proceeds to step 250, in which the braking force is increased according to the selected one of the above-described braking force recovery schedules. In other words, the braking force is increased over time at the braking force recovery rate Rbu(t) (one of Mapu1(t), Mapu2(t) and Mapu3(t)) from the braking force reduction lower bound Fbdo (one of Fbd1, Fbd2 and Fbd3).

Next, the control proceeds to step 260, in which determination is made as to whether the braking force Fb is increased to the recovery upper bound Fbuo (one of Fbu1, Fbu2 and Fbu3). If negative, the control returns to before step 240. Then, while confirmation is made in step 240 as to whether the braking is being applied, the control in step 250 is repeatedly performed. If the answer in step 240 changes from affirmative to negative, i.e., if the driver releases the depression of the brake pedal or the ECU ends the automatically controlled braking operation, the control proceeds to step 270, in which the brakes are released and the control ends.

If the determination in step 260 changes from negative to affirmative, the driving and braking force control in this cycle ends.

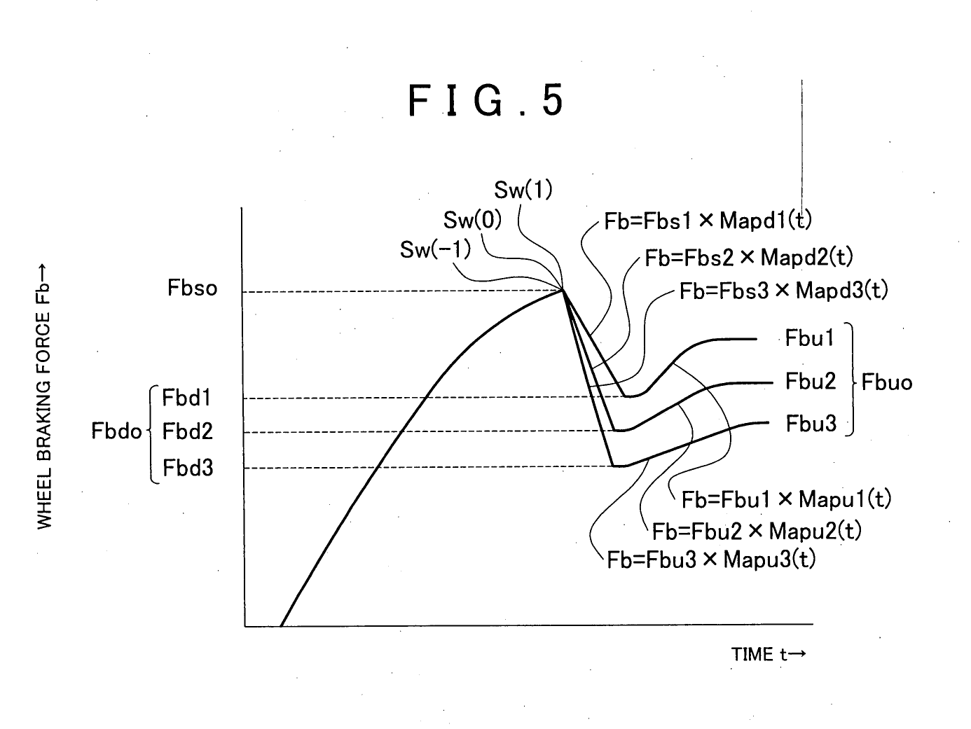

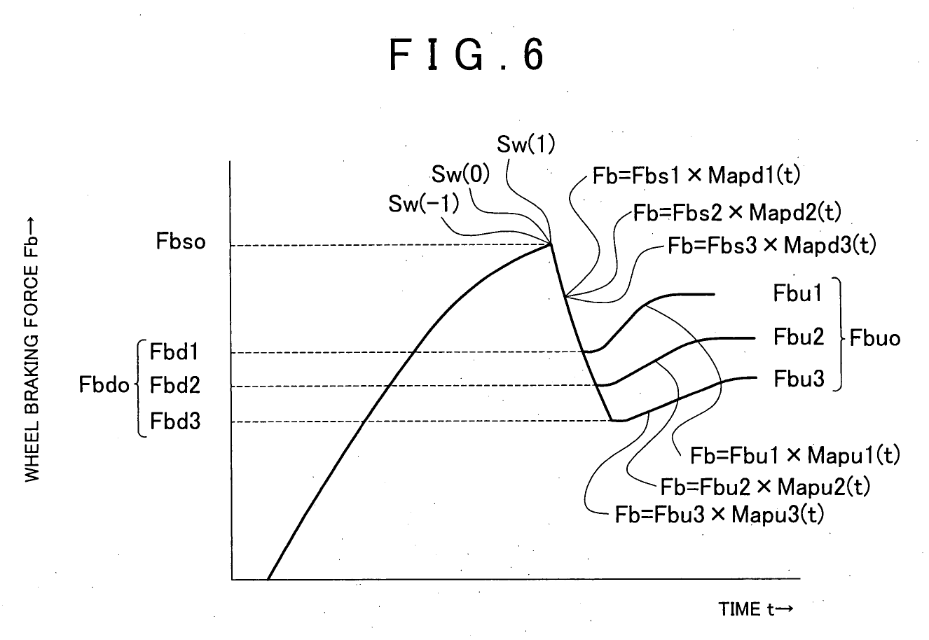

FIG. 5 is a map similar to that of FIG. 4, but the slip rate threshold value Swo(f) in the above-described step 110 is set constant regardless of the flag f. FIG. 6 is a map similar to those of FIGS. 4 and 5, but the reduction rates Mapd1(t), Mapd2(t) and Mapd3(t) respectively set in steps 130, 160 and 150 are identical. The control according to the flowcharts of FIGS. 3A and 3B may be performed using the map of FIG. 5 or FIG. 6, instead of FIG. 4. It is obviously understood that such a control has some merits and advantages similar to those obtained by the map of FIG. 4.

Further, as described above, the slip reduction performance of the wheel is determined based on the product of the friction coefficient between the road surface and the wheel and the wheel vertical load. Accordingly, when a tire chain or a studless tire is mounted on the wheel, and thus the friction coefficient between the road surface and the wheel increases, the change rate in wheel vertical load may be “rated augmentatively.” The change rate in wheel vertical load may be “rated augmentatively,” for example, in the following manner. When the chain/non-standard tire detector as shown in FIG. 2 detects that the wheel wears a chain or a non-standard tire, δFz1l and δFz2 in steps 40 and 50 may be reduced appropriately, and the absolute value of −δFz3 and −δFz4 in steps 70 and 80 may be reduced appropriately. Thus, the lower limit of the increasing rate in the wheel vertical load to set the flag f to one (1) may be set to a lower value. Also, the lower limit of the absolute value of the reduction rate in the wheel vertical load to set the flag f to minus one (−1) may be set to a lower value. Thus, the criteria in setting flag f may be changed to “augmentatively rate” the change rate in wheel vertical load. Alternatively, the change rate in wheel vertical load may be “rated augmentatively” by multiplying the change rate by a predetermined weight value (more than one (1)), or by adding the change rate and a predetermined value (a positive value when the vertical load is increasing, and a negative value when the vertical load is decreasing). The braking force in the above-described embodiment may be replaced by a brake oil pressure.

Further, when the road condition detector detects temporary changes in the wheel vertical load caused by the impulse-like protrusions or bumps (uneven road surfaces), it may be possible that ABS or TRC described above is not performed regardless of the slip rate Sw of the wheels. If the ABS or TRC is being performed, the ABS or TRC may be stopped.

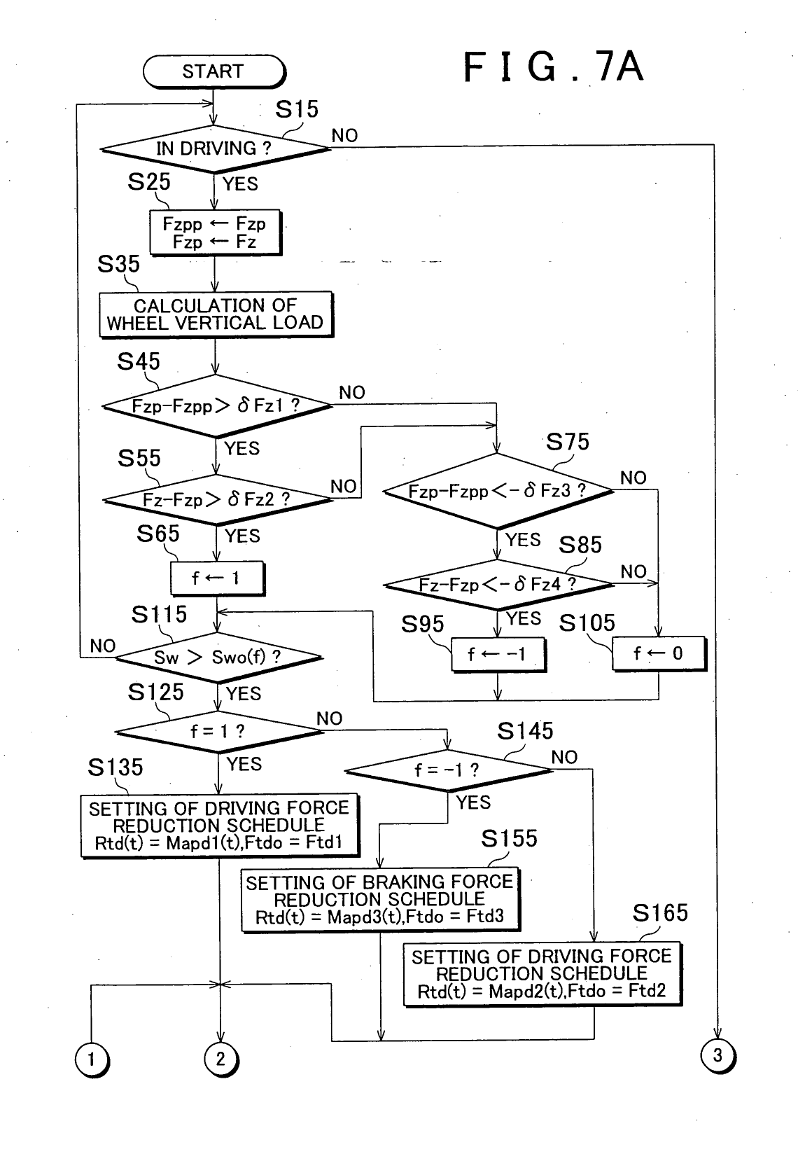

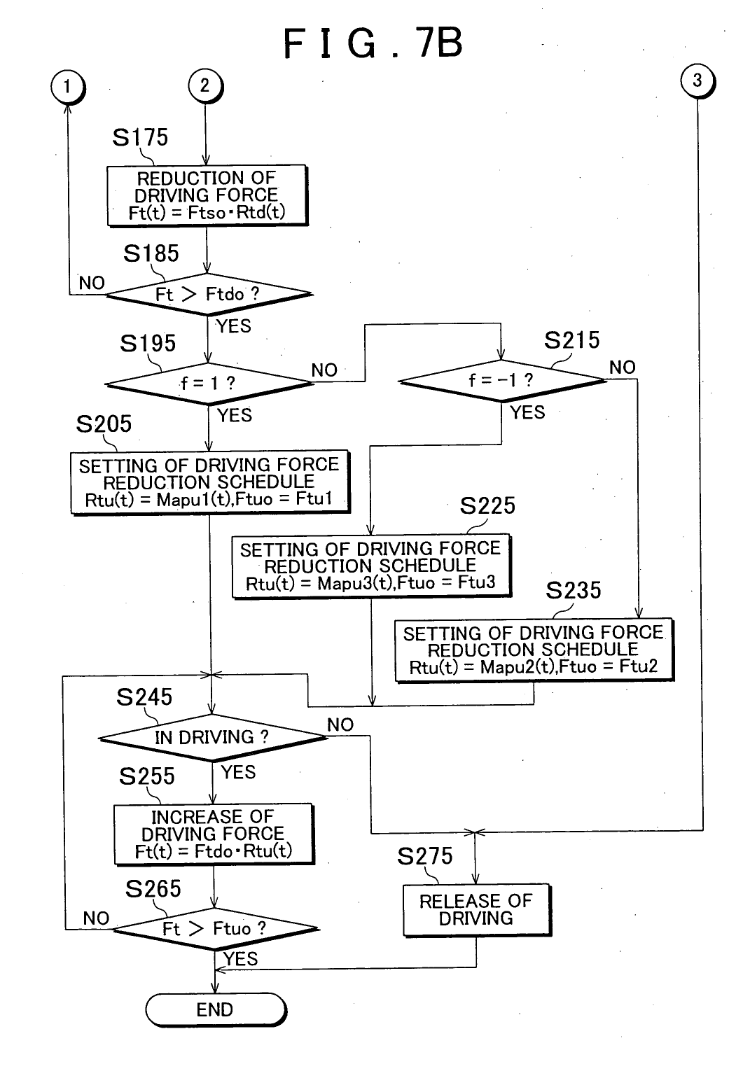

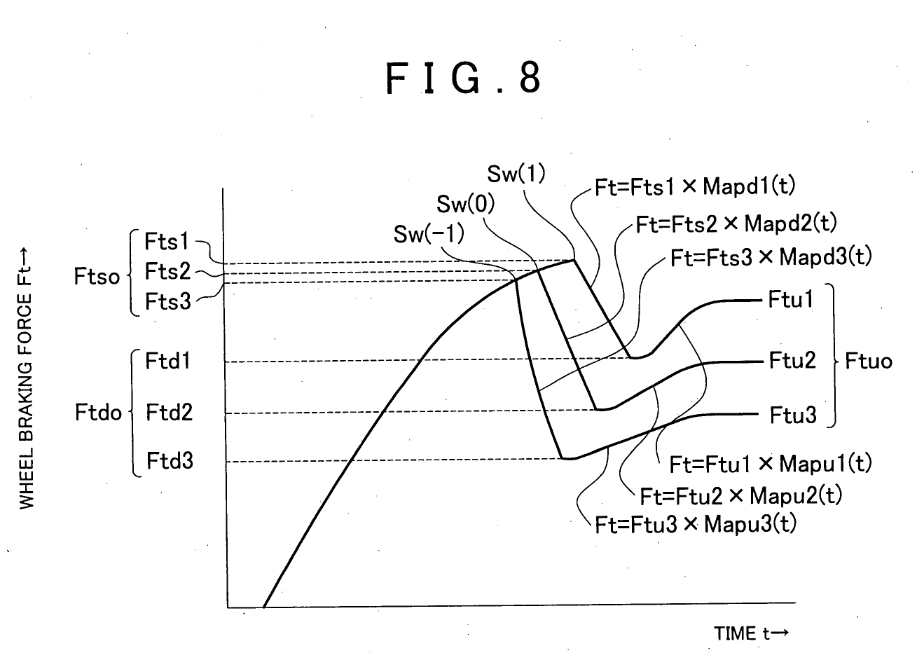

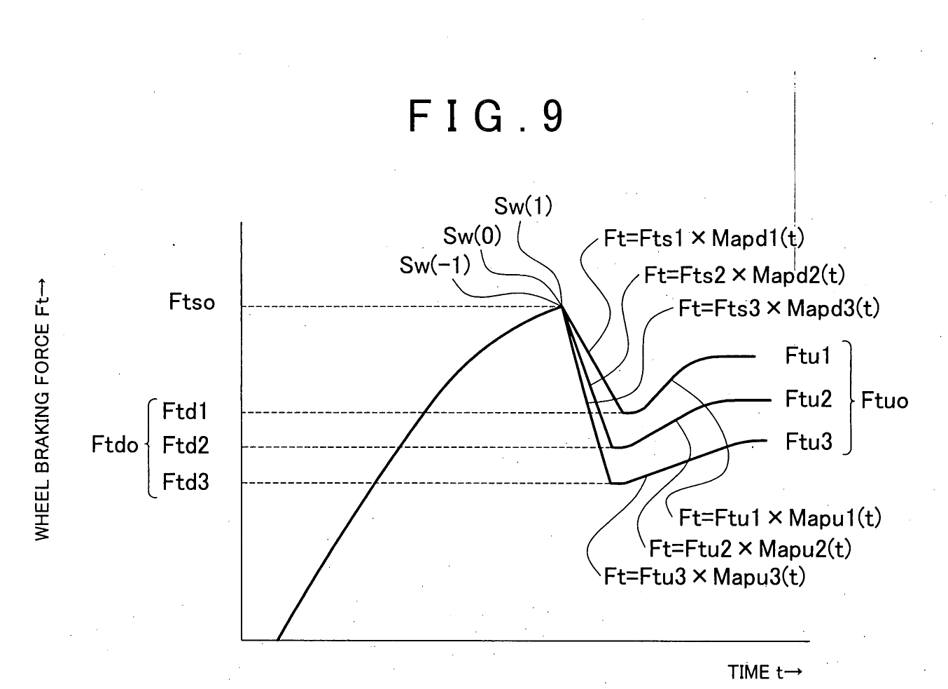

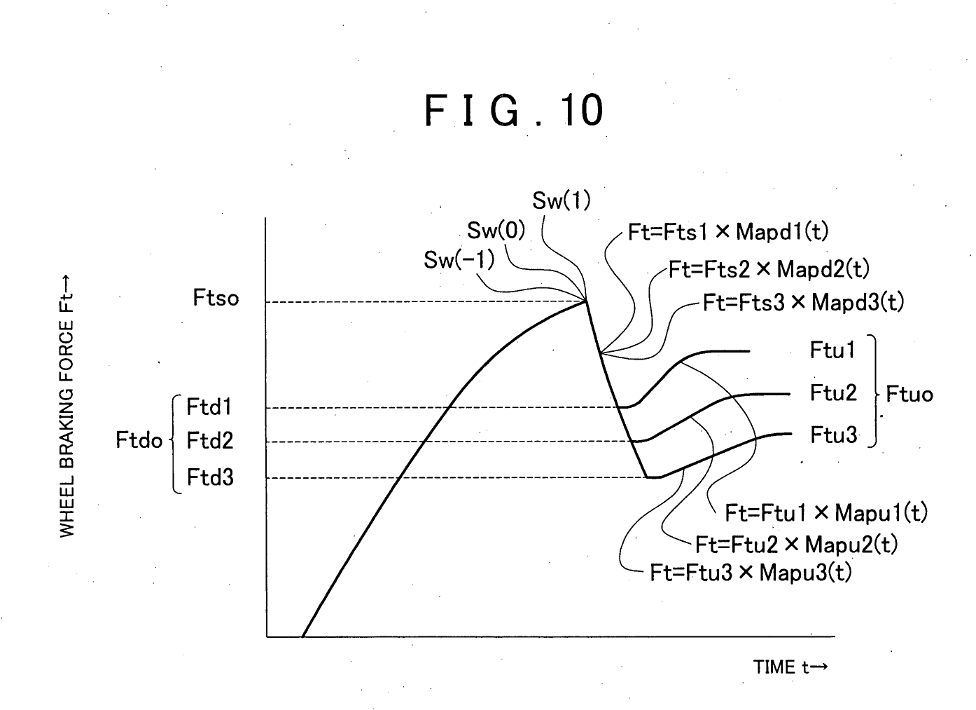

The driving and braking force control that is used when the wheel is braked and is described above with reference to FIGS. 3A to 6, may be similarly used in the driving control (TRC control) when the wheel is driven. FIGS. 7A to 10 are a flowchart and maps, which are used in the driving and braking force control when the wheel is driven, and respectively correspond to those in FIGS. 3A to 6, which are used in the driving and braking force control when the wheel is braked. When the wheel is driven, the temporary reduction of driving force in TRC control may be achieved by temporarily reducing a fuel injection in the engine or temporarily loosening the engagement of clutches that are mounted in the wheel driving system. Because the TRC control performed when the wheel is driven is similar to the ABS control preformed when the wheel is braked, the step numbers in FIGS. 7A and 7B are provided by adding the respective step numbers in FIGS. 3A and 3B and five (5). Further, in FIGS. 7A to 10, parameter names are provided by replacing “b” in the respective parameter name shown in FIGS. 3A to 6 by “t”. Note that “b” means braking and “t” means driving. Detailed description of FIGS. 7A to 10 are omitted to avoid redundancy of the specification.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

What is claimed is:

1. A vehicle comprising:
a controller that performs, when a slip between a wheel and a road surface is increased, a driving and braking force control to reduce the slip;
a change rate calculator that determines a change rate in a wheel vertical load; and
a mode calculator that changes a mode of the driving and braking force control based on the change rate determined by the change rate calculator.

2. The vehicle according to claim 1, wherein the change rate calculator determines whether the wheel vertical load increases,
the mode calculator changes the mode by setting a threshold value to greater when the wheel vertical load increases, as compared with when the wheel vertical load does not increase, and
the controller starts performing the driving and braking force control when a slip rate between the wheel and the road surface exceeds the threshold value.

3. The vehicle according to claim 1, wherein the change rate calculator determines whether the wheel vertical load decreases,
the mode calculator changes the mode by setting a threshold value to smaller when the wheel vertical load decreases, as compared with when the wheel vertical load does not decrease, and
the controller starts performing the driving and braking force control when a slip rate between the wheel and the road surface exceeds the threshold value.

4. The vehicle according to claim 1, wherein the controller reduces a force applied to the wheel along the road surface to a predetermined value and then gradually increases the force,
the change rate calculator determines whether the wheel vertical load increases, and
the mode calculator changes the mode by setting the predetermined value to greater when the wheel vertical load increases, as compared with when the wheel vertical load does not increase.

5. The vehicle according to claim 1, wherein the controller reduces a force applied to the wheel along the road surface to a predetermined value and then gradually increases the force,
the change rate calculator determines whether the wheel vertical load decreases, and
the mode calculator changes the mode by setting the predetermined value to smaller when the wheel vertical load decreases, as compared with when the wheel vertical load does not decrease.

6. The vehicle according to claim 1, wherein the controller reduces a force applied to the wheel along the road surface to a predetermined value and then gradually increases the force,
the change rate calculator determines whether the wheel vertical load increases, and
the mode calculator changes the mode by setting a greater increasing rate at which the controller increases the force when the wheel vertical load increases, as compared with when the wheel vertical load does not increase.

7. The vehicle according to claim 1, wherein the controller reduces a force applied to the wheel along the road surface to a predetermined value and then gradually increases the force,
the change rate calculator determines whether the wheel vertical load decreases, and
the mode calculator changes the mode by setting a smaller increasing rate at which the controller increases the force when the wheel vertical load decreases, as compared with when the wheel vertical load does not decrease.

8. The vehicle according to claim 1, wherein the controller reduces a force applied to the wheel along the road surface to a predetermined value and then gradually increases the force,
the change rate calculator determines whether the wheel vertical load increases, and
the mode calculator changes the mode by setting a smaller reduction rate at which the controller reduces the force when the wheel vertical load increases, as compared with when the wheel vertical load does not increase.

9. The vehicle according to claim 1, wherein the controller reduces a force applied to the wheel along the road surface to a predetermined value and then gradually increases the force,
the change rate calculator determines whether the wheel vertical load decreases, and
the mode calculator changes the mode by setting a greater reduction rate at which the controller reduces the force when the wheel vertical load decreases, as compared with when the wheel vertical load does not decrease.

10. The vehicle according to claim 1, further comprising a chain/non-standard tire detector that detects whether the wheel wears at least one of a chain and a non-standard tire, wherein
the mode calculator changes the mode so that the change rate in the wheel vertical load is augmentatively rated when the wheel wears at least one of the chain and the non-standard tire, as compared with when the wheel wears neither the tire chain nor the non-standard tire.

11. The vehicle according to claim 1, further comprising a road condition detector that detects an impulse-like protrusion on the road surface, wherein
the mode calculator determines the mode so that the controller ignores a temporary change in the wheel vertical load caused by the detected impulse-like protrusion.

12. The vehicle according to claim 1, further comprising a road condition detector that detects a bump on the road surface, wherein
the mode calculator determines the mode so that the controller ignores a temporary change in the wheel vertical load caused by the detected bump.

13. The vehicle according to claim 1, wherein the driving and braking force control is performed in an anti-lock braking system control.

14. The vehicle according to claim 1, wherein the driving and braking force control is performed in a traction control.

15. A method for controlling a vehicle, comprising:
determining a change rate in a wheel vertical load;
changing a mode of a driving and braking force control based on the determined change rate in the wheel vertical load; and
performing the driving and braking force control based on the changed mode to reduce a slip between a wheel and a road surface, when the slip is increased.

16. The method according to claim 15, wherein
the determining determines that the wheel vertical load increases, the mode is changed by setting a threshold value to greater when the wheel vertical load increases, as compared with when the wheel vertical load does not increase, and
the driving and braking force control starts when a slip rate between the wheel and the road surface exceeds the threshold value.

17. The method according to claim 15, wherein
determining determines that the wheel vertical load decreases,
the mode is changed by setting a threshold value to smaller when the wheel vertical load decreases, as compared with when the wheel vertical load does not decrease, and
the driving and braking force control starts when a slip rate between the wheel and the road surface exceeds the threshold value.

18. The method according to claim 15, wherein
determining determines that the wheel vertical load increases,
the mode is changed by setting a predetermined value to greater when the wheel vertical load increases, as compared with when the wheel vertical load does not increase, and
the driving and braking force control is performed so that a force applied to the wheel along the road surface is reduced to the predetermined value and then gradually increases.

19. The method according to claim 15, wherein
determining determines that the wheel vertical load decreases,
the mode is changed by setting a predetermined value to smaller when the wheel vertical load decreases, as compared with when the wheel vertical load does not decrease, and
the driving and braking force control is performed so that a force applied to the wheel along the road surface is reduced to the predetermined value and then gradually increases.

20. The method according to claim 15, wherein
determining determines that the wheel vertical load increases,
the mode is changed by setting an increasing rate to greater when the wheel vertical load increases, as compared with when the wheel vertical load does not increase, and
the driving and braking force control is performed so that a force applied to the wheel along the road surface is reduced to a predetermined value and then increases at the set increasing rate.

21. The method according to claim 15, wherein
determining determines that the wheel vertical load decreases,
the mode is changed by setting an increasing rate to smaller when the wheel vertical load decrease, as compared with when the wheel vertical load does not decrease, and
the driving and braking force control is performed so that a force applied to the wheel along the road surface is reduced to a predetermined value and then increases at the set increasing rate.

22. The method according to claim 15, wherein
determining determines that the wheel vertical load increase,
the mode is changed by setting a reduction rate to smaller when the wheel vertical load increase, as compared with when the wheel vertical load does not increase, and
the driving and braking force control is performed so that a force applied to the wheel along the road surface is reduced at the set reduction rate to a predetermined value and then gradually increases.

23. The method according to claim 15, wherein
determining determines that the wheel vertical load decrease the mode is changed by setting a reduction rate to greater when the wheel vertical load decrease, as compared with when the wheel vertical load does not decrease, and
the driving and braking force control is performed so that a force applied to the wheel along the road surface is reduced at the set reduction rate to a predetermined value and then gradually increases.

24. The method according to claim 15, further comprising detecting whether the wheel wears at least one of a chain and a non-standard tire, wherein
the mode is changed so that the change rate in the wheel vertical load is rated augmentatively when the wheel wears at least one of the chain and the non-standard tire, as compared with when the wheel wears neither the tire chain nor the non-standard tire.
